(19) United States
(12) Patent Application Publication
(10) Pub. No.: US 2005/0011304 A1
(43) Pub. Date: Jan. 20, 2005

(54) Crank structure of bicycle

(76) Inventor: Douglas Chiang, Taichung (TW)

Correspondence Address: Douglas Chiang, 58, MA YUAN WEST ST., TAICHUNG, TW

(21) Appl. No.: 10/620,978

(22) Filed: Jul. 14, 2003

(51) Int. Cl. G05G 1/14

(52) U.S. Cl. 74/594.1

(57) ABSTRACT

A crank structure includes a main body, a crank shaft, and a composite material layer. In assembly, after the crank shaft is mounted on the main body in a close fit manner, the composite material layer is coated around the outer periphery of the main body, so that the main body and the crank shaft have an enhanced combination strength. Thus, the crank shaft mounted on the main body in a close fit manner will not detach from the main body during travel of the bicycle.

### BACKGROUND OF THE INVENTION

1. Field of the Invention

The present invention relates to a crank structure, and more particularly to a crank structure of a bicycle.

2. Description of the Related Art

A conventional crank of a bicycle comprises a main body having a front end provided with a primary aluminum member and a rear end provided with a secondary aluminum member, an outer layer made of carbon fiber coated on the periphery of the primary aluminum member and the secondary aluminum member of the main body, a crank shaft screwed into the primary aluminum member of the main body, and a pedal screwed onto the secondary aluminum member of the main body.

However, the crank shaft is screwed onto the primary aluminum member of the main body, so that the crank shaft is easily detached from the main body during a long-term utilization. In addition, the primary aluminum member and the secondary aluminum member of the main body are coated with the outer layer made of carbon fiber, so that when the crank shaft is screwed into the screw bore of the primary aluminum member of the main body, the outer layer made of carbon fiber is easily broken.

### SUMMARY OF THE INVENTION

The primary objective of the present invention is to provide a crank structure, wherein the main body and the crank shaft are made of aluminum alloy material having a greater structural strength, thereby enhancing the structural strength of the main body and the crank shaft of the L-shaped crank structure.

Another objective of the present invention is to provide a crank structure, wherein the main body is integrally formed with the wing plates, thereby enhancing the combination strength of the main body and the chain wheel.

A further objective of the present invention is to provide a crank structure, wherein the main body is integrally formed with the wing plates, without having to assemble the wing plates additionally, so that the crank structure can be assembled rapidly, easily and conveniently.

A further objective of the present invention is to provide a crank structure, wherein after the crank shaft is mounted on the main body in a close fit manner, the composite material layer is coated around the outer periphery of the main body, so that the main body and the crank shaft have an enhanced combination strength. Thus, the crank shaft mounted on the main body in a close fit manner will not detach from the main body during travel of the bicycle.

A further objective of the present invention is to provide a crank structure, wherein the crank shaft is mounted on the second mounting portion of the main body, and the composite material layer is then coated around the outer periphery of the main body, so that the composite material layer coated around the outer periphery of the main body will not be broken easily.

A further objective of the present invention is to provide a crank structure, wherein the crank structure is made of aluminum alloy material and carbon fiber material, so that the crank structure has an enhanced structural strength and has a light weight.

In accordance with the preferred embodiment of the present invention, there is provided a crank structure, comprising a main body, and a crank shaft, wherein:
the main body has a first end provided with a first mounting portion and a second end provided with a second mounting portion; and
the crank shaft is mounted on the second mounting portion of the main body in a close fit manner.

In accordance with another embodiment of the present invention, there is provided a crank structure, comprising:
a main body;
a first mounting member mounted on a first end of the main body;
a second mounting member mounted on a second end of the main body; and
a crank shaft extended from the second mounting member.

Further benefits and advantages of the present invention will become apparent after a careful reading of the detailed description with appropriate reference to the accompanying drawings.

### BRIEF DESCRIPTION OF THE DRAWINGS

FIG. 1 is a partially perspective view of a crank structure in accordance with the preferred embodiment of the present invention;

FIG. 2 is a perspective view of the crank structure in accordance with the preferred embodiment of the present invention;

FIG. 3 is a plan cross-sectional view of the crank structure as shown in FIG. 1;

FIG. 4 is a plan cross-sectional view of the crank structure as shown in FIG. 2;

FIG. 5 is an exploded perspective view of the crank structure in accordance with the preferred embodiment of the present invention;

FIG. 6 is a perspective assembly view of the crank structure in accordance with the preferred embodiment of the present invention;

FIG. 7 is a partially perspective view of a crank structure in accordance with another embodiment of the present invention; and

FIG. 8 is a perspective view of the crank structure in accordance with another embodiment of the present invention.

### DETAILED DESCRIPTION OF THE INVENTION

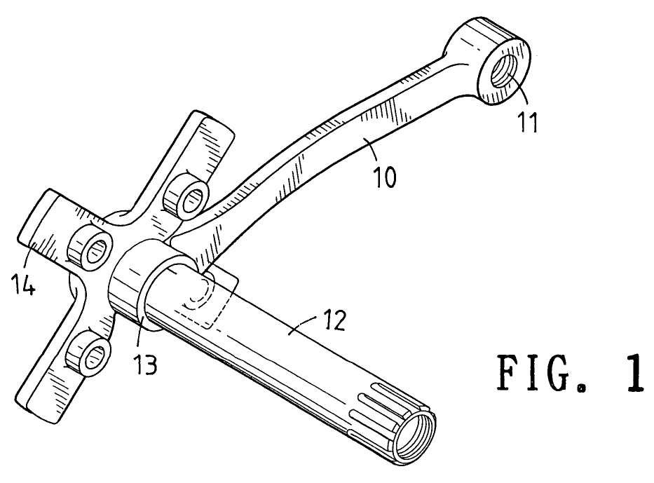

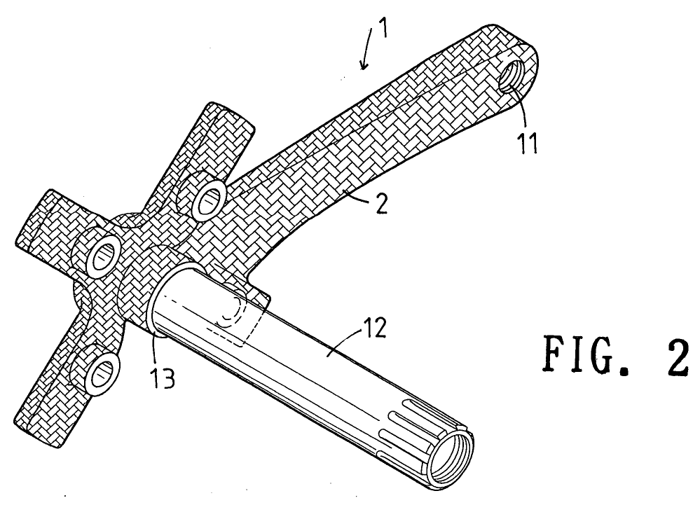

Referring to the drawings and initially to FIGS. 1-5, a crank structure 1 of a bicycle in accordance with the preferred embodiment of the present invention comprises a main body 10, and a crank shaft 12.

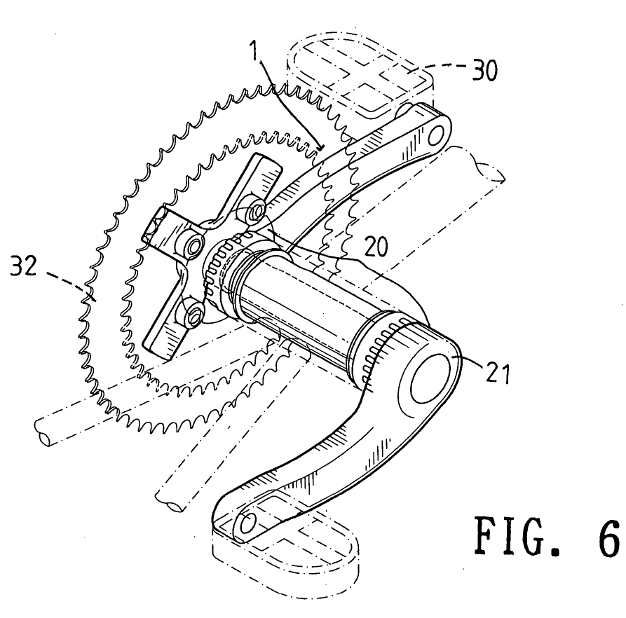

The main body 10 is made of aluminum alloy material and is formed by forging. The main body 10 has a first end provided with a first mounting portion 11 for connection to a pedal 30 (see FIG. 6), and a second end provided with a second mounting portion 13. The second mounting portion 13 of the main body 10 has a periphery provided with a plurality of protruding wing plates 14 for connection to a chain wheel 32 (see FIG. 6). Preferably, the second mounting portion 13 of the main body 10 is integrally formed with the wing plates 14.

The crank shaft 12 is a hollow body which is made of aluminum alloy material and is formed by forging. The crank shaft 12 is mounted on the second mounting portion 13 of the main body 10 in a close fit manner.

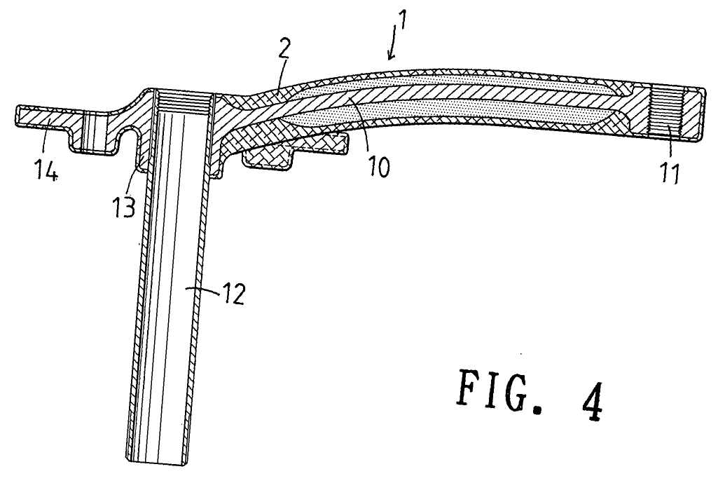

The crank structure 1 further comprises a composite material layer 2 (see FIG. 4) coated around an outer periphery of the main body 10. The composite material layer 2 is made of carbon fiber material.

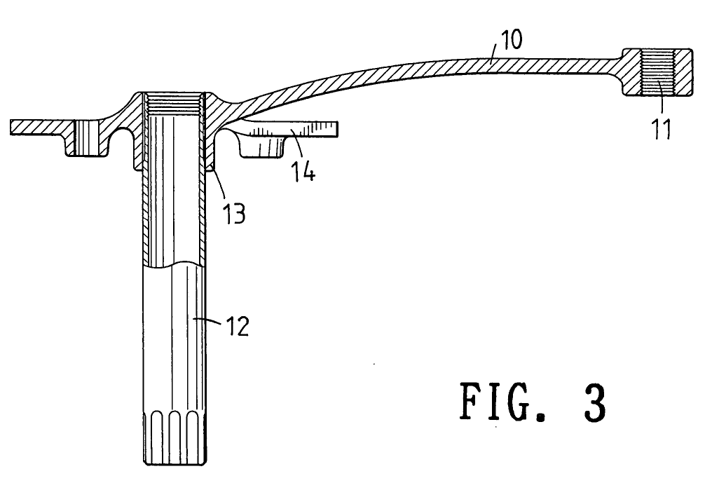

Thus, as shown in FIGS. 3 and 4, after the crank shaft 12 is mounted on the second mounting portion 13 of the main body 10 in a close fit manner, the composite material layer 2 is coated around the outer periphery of the main body 10, so that the main body 10 and the crank shaft 12 form the crank structure 1 having an enhanced combination strength.

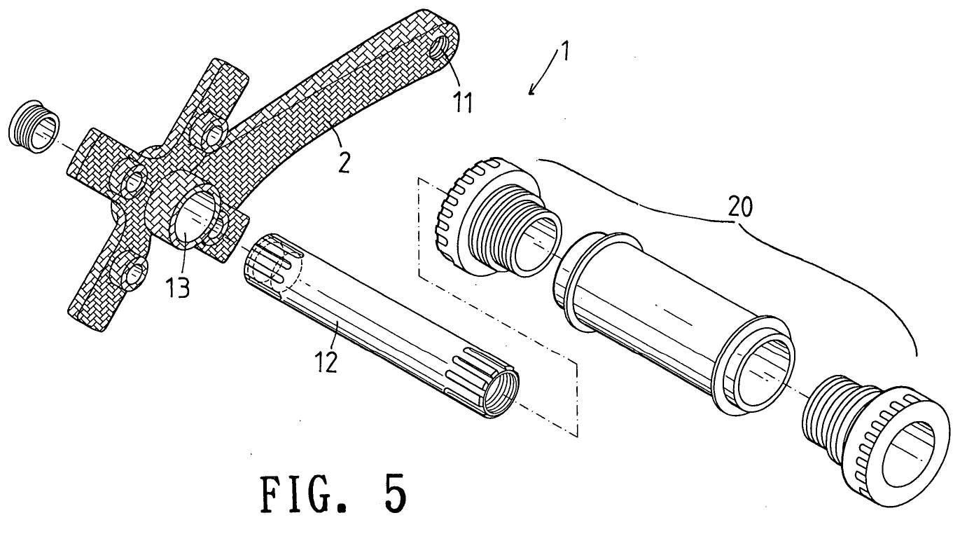

In assembly, as shown in FIGS. 5 and 6, the crank shaft 12 of the crank structure 1 is extended through the bottom bracket 20 of the bicycle and is connected to a crank 21 at the other side, so that the crank structure 1 can be assembled rapidly, easily and conveniently.

Accordingly, the crank structure 1 in accordance with the present invention has the following advantages.

The main body 10 and the crank shaft 12 are made of aluminum alloy material having a greater structural strength, thereby enhancing the structural strength of the main body 10 and the crank shaft 12 of the L-shaped crank structure 1.

In addition, the main body 10 is integrally formed with the wing plates 14, thereby enhancing the combination strength of the main body 10 and the chain wheel 32.

Further, the main body 10 is integrally formed with the wing plates 14, without having to assemble the wing plates 14 additionally, so that the crank structure 1 can be assembled rapidly, easily and conveniently.

Further, after the crank shaft 12 is mounted on the main body 10 in a close fit manner, the composite material layer 2 is coated around the outer periphery of the main body 10, so that the main body 10 and the crank shaft 12 have an enhanced combination strength. Thus, the crank shaft 12 mounted on the main body 10 in a close fit manner will not detach from the main body 10 during travel of the bicycle.

Further, the crank shaft 12 is mounted on the second mounting portion 13 of the main body 10, and the composite material layer 2 is then coated around the outer periphery of the main body 10, so that the composite material layer 2 coated around the outer periphery of the main body 10 will not be broken easily.

Further, the crank structure 1 is made of aluminum alloy material and carbon fiber material, so that the crank structure 1 has an enhanced structural strength and has a light weight.

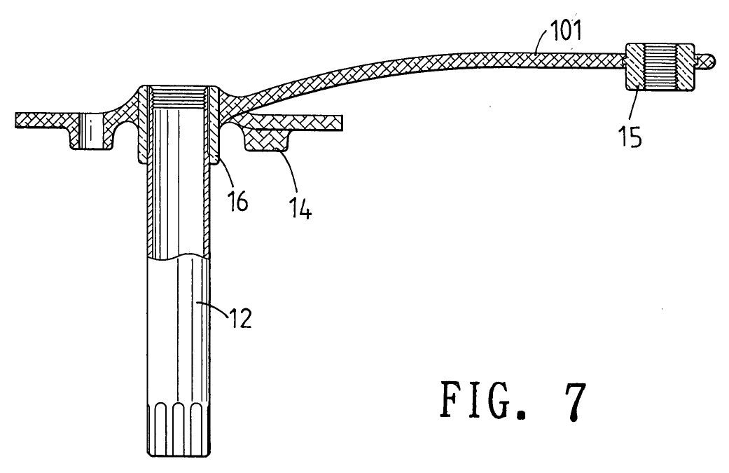

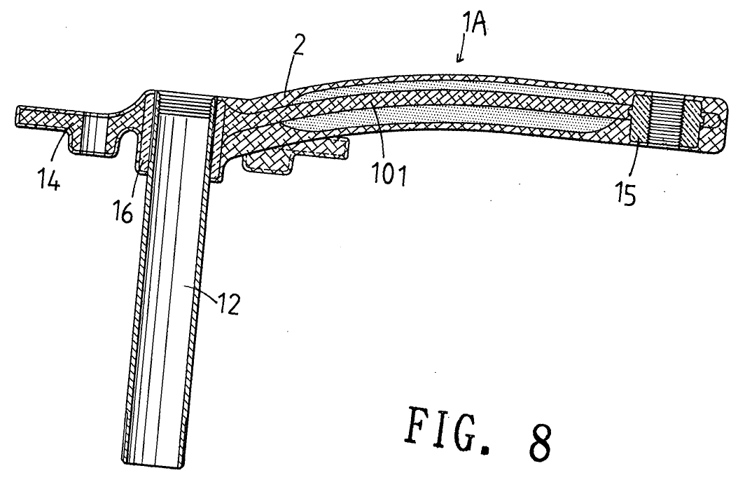

Referring to FIGS. 7 and 8, a crank structure 1A of a bicycle in accordance with another embodiment of the present invention comprises a main body 101, a first mounting member 15 mounted on a first end of the main body 101, a second mounting member 16 mounted on a second end of the main body 101, and a crank shaft 12 integrally formed on and extended from the second mounting member 16.

The main body 101 is made of carbon fiber material and has an L-shaped profile. The first mounting member 15 is made of aluminum alloy material and is formed by forging. The second mounting member 16 is made of aluminum alloy material and is formed by forging.

In assembly, a carbon fiber composite material is coated around the first mounting member 15 and the second mounting member 16, thereby forming the main body 101 coated with the first mounting member 15 and the second mounting member 16. In addition, the second end of the main body 101 and the second mounting member 16 have a periphery provided with a plurality of protruding wing plates 14 for connection to the chain wheel 32 (see FIG. 6). Then, the periphery of the main body 101, the first mounting member 15 and the second mounting member 16 is coated with a resin and a composite material layer 2 made of carbon fiber material, thereby forming the crank structure 1A having an enhanced combination strength.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A crank structure, comprising a main body, and a crank shaft, wherein:
the main body has a first end provided with a first mounting portion and a second end provided with a second mounting portion; and
the crank shaft is mounted on the second mounting portion of the main body in a close fit manner.

2. The crank structure in accordance with claim 1, wherein the main body is made of aluminum alloy material.

3. The crank structure in accordance with claim 1, wherein the main body and the crank shaft form an L-shaped profile.

4. The crank structure in accordance with claim 1, wherein the second mounting portion of the main body has a periphery provided with a plurality of protruding wing plates.

5. The crank structure in accordance with claim 4, wherein the second mounting portion of the main body is integrally formed with the wing plates.

6. The crank structure in accordance with claim 1, wherein the crank shaft is a hollow body made of aluminum alloy material.

7. The crank structure in accordance with claim 1, further comprising a composite material layer coated around an outer periphery of the main body.

8. The crank structure in accordance with claim 7, wherein the composite material layer is made of carbon fiber material.

9. The crank structure in accordance with claim 1, wherein after the crank shaft is mounted on the second mounting portion of the main body in a close fit manner, the composite material layer is coated around the outer periphery of the main body, so that the main body and the crank shaft form the crank structure having an enhanced combination strength.

10. A crank structure, comprising:
a main body;
a first mounting member mounted on a first end of the main body;
a second mounting member mounted on a second end of the main body; and
a crank shaft integrally formed on and extended from the second mounting member.

11. The crank structure in accordance with claim 10, wherein the main body is integrally coated with the first mounting member and the second mounting member.

12. The crank structure in accordance with claim 10, wherein the main body is made of carbon fiber material.

13. The crank structure in accordance with claim 10, wherein the main body and the crank shaft form an L-shaped profile.

14. The crank structure in accordance with claim 10, further comprising a composite material layer coated around an outer periphery of the main body, the first mounting member and the second mounting member.

15. The crank structure in accordance with claim 14, wherein the composite material layer is made of carbon fiber material.

16. The crank structure in accordance with claim 10, wherein the first mounting member is made of aluminum alloy material.

17. The crank structure in accordance with claim 10, wherein the second mounting member is made of aluminum alloy material.

18. The crank structure in accordance with claim 10, wherein the second end of the main body and the second mounting member have a periphery provided with a plurality of protruding wing plates.
